(19) United States
(12) Patent Application Publication
(10) Pub. No.: US 2026/0155279 A1
(43) Pub. Date: Jun. 4, 2026

(54) JACKET FOR AN ELECTRICAL CABLE

(71) Applicant: WildStar LLC, Saratoga, CA (US)

(72) Inventors: Guan Che Ting, San Jose, CA (US); Jacob Miles Peery, Hermosa Beach, CA (US)

(73) Assignee: WildStar LLC, Saratoga, CA (US)

(21) Appl. No.: 19/408,344

(22) Filed: Dec. 3, 2025

Related U.S. Application Data
(60) Provisional application No. 63/727,633, filed on Dec. 3, 2024.

(51) Int. Cl. H01B 7/18; H01B 7/00; H01B 7/42

(52) U.S. Cl. CPC H01B 7/184; H01B 7/0009; H01B 7/1875; H01B 7/426

(57) ABSTRACT

The disclosed technology is generally directed to electrical cables. In one example of the technology, the electrical cable includes a conductor and a jacket. The conductor has a cross-sectional profile and an outer surface with a circumference. The jacket surrounds the conductor. The jacket includes an inner surface and an outer surface. The inner surface has a first cross-sectional profile that is substantially uniform with respect to the cross-sectional profile of the conductor. The outer surface has a second cross-sectional profile that is substantially non-uniform with respect to the cross-sectional profile of the conductor and the first cross-sectional profile.

### RELATED APPLICATIONS

This application claims the benefit of U.S. Provisional Application Number 63/727,633, filed on Dec. 3, 2024, which is incorporated herein by reference in its entirety.

### TECHNICAL FIELD

This disclosure is directed to electrical cables, and more particularly, to a jacket for electrical cables.

### BACKGROUND

Electrical cables are commonly used in many different applications to carry electrical current. The structure of an electrical cable can vary depending on the application. For example, a single core electrical cable typically refers to a single conductor (or wire), or multiple strands of the conductor, surrounded and insulated by a jacket. By contrast, a multicore electrical cable typically refers to multiple conductors (or wires) bundled together that are, in turn, encased in another jacket (e.g., multiple insulated wires encased in, and insulated by, an additional outer jacket). Single core electrical cables are normally used for single electrical paths, whereas multicore electrical cables are often used for more complex or multipath electrical connections.

Jackets for electrical cables are important for a variety of reasons including that they serve to insulate, protect, and provide structural integrity to the conductors inside. For example, the jackets may provide protection to electrical conductors or wires of an electrical cable from environmental factors (e.g., moisture, chemicals, and other environmental hazards that may degrade the conductor), mechanical damage (e.g., cuts, abrasion, and impact), and electrical interference (e.g., by preventing electrical leakage and/or protecting the conductor from external electrical interference). The jackets may help ensure the safety, reliability, and efficiency of electrical systems across multiple industries, including automotive, aerospace, industrial, and consumer electronics.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, an exemplary embodiment of the present disclosure may provide a single core electrical cable. The single core electrical cable may have a longitudinal axis along the length of the single core electrical cable. The single core electrical cable may include a single conductor having a cross-sectional profile and an outer surface with a circumference, and a single jacket encasing the single conductor. The single jacket includes an inner surface and an outer surface. The inner surface may surround the single conductor, and have a first cross-sectional profile that is substantially uniform with respect to the cross-sectional profile of the single conductor. In accordance with the disclosed embodiments, the outer surface may have a plurality of surface features extending along the longitudinal axis of the single core electrical cable. The plurality of surface features define a non-linear circumference configured to enhance thermal dissipation. The outer surface may have a second cross-sectional profile that is substantially non-uniform with respect to the cross-sectional profile of the single conductor and the first cross-sectional profile.

In one embodiment, the plurality of surface features of the outer surface of the single jacket may comprise a plurality of longitudinal projections extending in a direction parallel to the longitudinal axis. The longitudinal projections may define the non-linear circumference and form longitudinal channels (also referred to as “valleys” herein) therebetween that are configured to increase convective heat transfer from the single conductor. The second cross-sectional profile of the outer surface has the non-linear circumference defined by the longitudinal projections and the longitudinal channels between the longitudinal projections. The longitudinal projections and the longitudinal channels may extend longitudinally along the length of and parallel to the longitudinal axis of the single core electrical cable. The longitudinal projections increase thermal transfer coefficient of the single jacket and increase thermal transfer from the single conductor.

In one embodiment, the outer surface may be a ribbed outer surface, where the plurality of surface features of the ribbed outer surface comprise a plurality of longitudinal ribs. Each longitudinal rib extends continuously or intermittently along the longitudinal axis and outwards from the inner surface such that the second cross-sectional profile of the ribbed outer surface has the non-linear circumference with respect to the circumference of the single conductor. In this embodiment, the plurality of longitudinal ribs create a plurality of longitudinal channels along the ribbed outer surface. In some implementations, each of the plurality of longitudinal ribs also extend longitudinally along the length of and parallel to the longitudinal axis of the single core electrical cable. In this embodiment, the plurality of longitudinal ribs form longitudinal ridges therebetween running parallel along length of the single conductor.

Depending on the implementation, the shape of each of the plurality of longitudinal ribs may vary. For example, the shape of the longitudinal ribs may correspond to one or more of a semi-circular shape, a triangular shape, a trapezoidal shape, and a saw tooth shape, etc.

In some embodiments, each of the plurality of longitudinal ribs may extend longitudinally along the length of and parallel to the longitudinal axis of the single core electrical cable. In one embodiment, the plurality of longitudinal ribs form straight longitudinal ridges extending around the single core electrical cable with an axial component of extension and a pitch greater than their height. In another embodiment, the plurality of longitudinal ribs form helical ridges extending around the single core electrical cable with an axial component of extension that forms partially-longitudinal channels. For instance, in one implementation, the helical ridges have a pitch greater than their height and extend around the single core electrical cable with a pitch angle between 5° and 85°.

As will be described below, the single jacket may be coated over the single conductor by way of an extrusion process using an extrusion die. The extrusion die may have a ribbed inner surface (or alternatively a fin-forming inner surface). The shape of the ribbed inner surface (or alternatively the fin-forming inner surface) of the extrusion die is complimentary to a shape of the ribbed outer surface of the single jacket.

In some embodiments, the single core electrical cable may also include an insulator surrounding the single conductor, and a shielding disposed on an external periphery of the insulator. In such embodiments, the insulator and the shielding may be disposed between the single conductor and the single jacket, and the single jacket may surround the shielding.

In some implementations, the plurality of surface features may increase the external convective heat transfer coefficient by at least 10% relative to a smooth cylindrical jacket of equal diameter. In some implementations, the ratio of height of the plurality of surface features to thickness of the single jacket is between 0.1 and 1.0. In some implementations, the outer surface exhibits at least a 5% increase in external surface area relative to a smooth cylindrical profile. In some implementations, the plurality of surface features act as spacers to maintain gap between the single core electrical cable and adjacent surfaces. In some implementations, the plurality of surface features deform elastically under radial compression to preserve channel geometry. In some implementations, the single jacket may comprise a polymer including thermally conductive but electrically insulating fillers. In some implementations, the plurality of surface features may comprise a material having higher thermal conductivity than the remainder of the single jacket.

In another aspect, an exemplary embodiment of the present disclosure may provide a multicore electrical cable.

The multicore electrical cable has a longitudinal axis along the length of the multicore electrical cable. The multicore electrical cable may comprise: a first set of conductors having a cross-sectional profile and an outer surface with a circumference; and a first jacket surrounding the first set of conductors. The first jacket may comprise an inner surface and an outer surface. The inner surface may have a first cross-sectional profile that is substantially uniform with respect to the cross-sectional profile of the first set of conductors. The outer surface may have a plurality of surface features extending along the longitudinal axis of the multicore electrical cable, the surface features defining a non-linear circumference configured to enhance thermal dissipation. The outer surface may have a second cross-sectional profile that is substantially non-uniform with respect to the cross-sectional profile of the first set of conductors and the first cross-sectional profile.

In one embodiment, the plurality of surface features of the outer surface of the first jacket may comprise a plurality of longitudinal projections that extend in a direction parallel to the longitudinal axis. The longitudinal projections define the non-linear circumference and form longitudinal channels therebetween, where the longitudinal channels are configured to increase convective heat transfer from the first set of conductors. The second cross-sectional profile of the outer surface has the non-linear circumference defined by the longitudinal projections and the longitudinal channels between the longitudinal projections. The longitudinal projections and the longitudinal channels may extend in a longitudinal direction along the length of the cable (i.e., in the same direction as the length of the cable). In some embodiments, the longitudinal projections and the longitudinal channels extend longitudinally along the length of and parallel to the longitudinal axis of the multicore electrical cable. The longitudinal projections increase thermal transfer coefficient of the first jacket and increase thermal transfer from the first set of conductors.

In one embodiment, the outer surface of the first jacket comprises a ribbed outer surface, and the plurality of surface features of the ribbed outer surface comprise a plurality of longitudinal ribs. Each longitudinal rib extends continuously or intermittently along the longitudinal axis and outwards from the inner surface such that the second cross-sectional profile of the ribbed outer surface has a non-linear circumference with respect to the circumference of the first set of conductors. The plurality of longitudinal ribs create a plurality of longitudinal channels therebetween along the ribbed outer surface.

In one embodiment, each of the plurality of longitudinal ribs also extend longitudinally along the length of and parallel to the longitudinal axis of the multicore electrical cable. In other words, the ribs may extend in a longitudinal direction along the length of the cable (i.e., in the same direction as the length of the cable). The plurality of longitudinal ribs form longitudinal ridges therebetween running parallel along length of the first set of conductors.

In one embodiment, a shape of each of the plurality of longitudinal ribs corresponds to at least one of a semi-circular shape, a triangular shape, a trapezoidal shape, and a saw tooth shape.

In one embodiment, each of the plurality of longitudinal ribs extend longitudinally along the length of and parallel to the longitudinal axis of the multicore electrical cable. In other words, the ribs extend in a longitudinal direction along the length of the cable (i.e., in the same direction as the length of the cable). In one implementation, the plurality of longitudinal ribs form straight longitudinal ridges extending around the multicore electrical cable with a pitch greater than the height, all of which include an axial component of extension. In another implementation, the plurality of longitudinal ribs form helical ridges extending around the multicore electrical cable with a pitch greater than the height, all of which include an axial component of extension.

In one embodiment, the first jacket is coated over the first set of conductors by way of an extrusion process using an extrusion die having a ribbed inner surface (or a fin-forming inner surface), as described above.

In one embodiment, the multicore electrical cable may also include a second jacket surrounding the first set of conductors, and a third jacket surrounding a second set of conductors. The first jacket surrounds the second jacket and the third jacket. The second jacket may have an inner surface and an outer surface. The inner surface may have a first cross-sectional profile that is substantially uniform with respect to the cross-sectional profile of the first set of conductors. The outer surface may have a second cross-sectional profile that is substantially uniform with respect to the cross-sectional profile of the first set of conductors and the first cross-sectional profile of the inner surface of the second jacket. The second set of conductors may have a cross-sectional profile and an outer surface with a circumference. The third jacket may surround the second set of conductors, and may also have an inner surface and an outer surface. The inner surface has a first cross-sectional profile that is substantially uniform with respect to the cross-sectional profile of the second set of conductors, whereas the outer surface has a second cross-sectional profile that is substantially uniform with respect to the cross-sectional profile of the second set of conductors and the first cross-sectional profile of the inner surface of the third jacket.

In one embodiment, the multicore electrical cable may also include a second set of conductors having a cross-sectional profile and an outer surface with a circumference, a second jacket surrounding the second set of conductors, and a third jacket surrounding the first jacket and the second jacket. In this embodiment, the second jacket may have an inner surface having a first cross-sectional profile that is substantially uniform with respect to the cross-sectional profile of the second set of conductors, and an outer surface having a plurality of surface features extending along the longitudinal axis of the multicore electrical cable. The surface features may define a non-linear circumference configured to enhance thermal dissipation. The outer surface may have a second cross-sectional profile that is substantially non-uniform with respect to the cross-sectional profile of the second set of conductors and the first cross-sectional profile of the inner surface of the second jacket. In one embodiment, the plurality of surface features of the outer surface of the second jacket comprise a plurality of longitudinal projections extending in a direction parallel to the longitudinal axis. The longitudinal projections define the non-linear circumference and form longitudinal channels therebetween that are configured to increase convective heat transfer from the second set of conductors. The second cross-sectional profile of the outer surface of the second jacket has the non-linear circumference defined by the longitudinal projections and the longitudinal channels between the longitudinal projections. The longitudinal projections and the longitudinal channels extend longitudinally along the length of and parallel to the longitudinal axis of the multicore electrical cable. The longitudinal projections increase thermal transfer coefficient of the second jacket and increase thermal transfer from the second set of conductors. The third jacket may have an inner surface having a first cross-sectional profile, and an outer surface having a plurality of surface features extending along the longitudinal axis of the multicore electrical cable. The surface features define a non-linear circumference configured to enhance thermal dissipation. The outer surface of the third jacket may have a second cross-sectional profile having a non-linear circumference defined by longitudinal projections and longitudinal channels between the longitudinal projections. The longitudinal projections and the longitudinal channels extend longitudinally along the length of and parallel to the longitudinal axis. The longitudinal projections increase thermal transfer coefficient of the third jacket and increase thermal transfer from the first jacket and the second jacket.

In one embodiment, the outer surface of the second jacket comprises a ribbed outer surface, where the plurality of surface features of the ribbed outer surface may comprise a plurality of longitudinal ribs. Each longitudinal rib may extend continuously, or intermittently, along the longitudinal axis and outwards from the inner surface of the second jacket such that the second cross-sectional profile of the ribbed outer surface of the second jacket has a non-linear circumference with respect to the circumference of the second set of conductors. the plurality of longitudinal ribs of the ribbed outer surface of the first jacket create a plurality of longitudinal channels along the ribbed outer surface that are adapted to engage with the plurality of longitudinal ribs of the ribbed outer surface of the second jacket to interlock the first set of conductors and the second set of conductors.

In one embodiment, the multicore electrical cable may also include an insulator surrounding the first set of conductors, and a shielding disposed on an external periphery of the insulator. The insulator and the shielding may be disposed between the first set of conductors and the first jacket, and wherein the first jacket surrounds the shielding.

In another aspect, an exemplary embodiment of the present disclosure may provide a method of manufacturing an electrical cable having a longitudinal axis along the length of the electrical cable. The method may comprise encasing a conductor in a polymer jacket, and extruding the polymer jacket through an extrusion die to encase the conductor. The conductor has a cross-sectional profile and an outer surface with a circumference. The polymer jacket has and outer surface and an inner surface surrounding the conductor, where the inner surface of the polymer jacket has a first cross-sectional profile that is substantially uniform with respect to the cross-sectional profile of the conductor. The extrusion die has a ribbed inner surface with projections that form a plurality of longitudinal ribs on the outer surface of the electrical cable to produce a ribbed outer surface. The projections have a shape that is complimentary to the shape of the ribbed outer surface of the jacket. The plurality of longitudinal ribs extend outward from the inner surface of the polymer jacket and along the longitudinal axis of the electrical cable. The plurality of longitudinal ribs create a plurality of longitudinal channels along the ribbed outer surface, and define a non-linear circumference configured to enhance thermal dissipation. As a result, the ribbed outer surface has a second cross-sectional profile that is substantially non-uniform with respect to the cross-sectional profile of the conductor and the first cross-sectional profile. The second cross-sectional profile has the non-linear circumference with respect to the circumference of the conductor.

Further aspects, features, applications, and advantages of the disclosed technology, as well as the structure and operation of various examples, are described in detail below with reference to the accompanying drawings. It is noted that the disclosed technology is not limited to the specific examples described herein. Such examples are presented herein for illustrative purposes only. Additional examples will be apparent to persons skilled in the relevant art(s) based on the teachings contained herein.

### BRIEF DESCRIPTION OF THE SEVERAL VIEWS OF THE DRAWINGS

For a better understanding of the present disclosure, non-limiting and non-exhaustive examples of the present disclosure are described with reference to the following drawings, in which:

FIGS. 1A and 1B are diagrams illustrating a perspective view and a sectional view of a single core electrical cable in which aspects of the technology may be employed;

FIGS. 2A and 2B are diagrams illustrating a perspective view and a sectional view of a multicore electrical cable in which aspects of the technology may be employed;

FIGS. 3A and 3B are diagrams illustrating a perspective view and a sectional view of yet another single core electrical cable in which aspects of the technology may be employed;

FIGS. 4A-4C are diagrams illustrating a perspective view, a sectional view, and a zoomed in view of a single core electrical cable in which aspects of the technology may be employed;

FIGS. 5A-5C are diagrams illustrating a perspective view, a sectional view, and a zoomed in view of another single core electrical cable in which aspects of the technology may be employed;

FIGS. 6A-6C are diagrams illustrating a perspective view, a sectional view, and a zoomed in view of yet another single core electrical cable in which aspects of the technology may be employed;

FIGS. 7A-7C are diagrams illustrating a perspective view, a sectional view, and a zoomed in view of yet another single core electrical cable in which aspects of the technology may be employed;

FIGS. 8A and 8B are diagrams illustrating a perspective view and a sectional view of interlocking between single core electrical cables in which aspects of technology may be employed;

FIGS. 9A and 9B are diagrams illustrating a perspective view and a sectional view of interlocking between single core electrical cables in which aspects of technology may be employed;

FIG. 10 is a diagram illustrating a multicore electrical cable having multiple single core electrical cables in which aspects of technology may be employed;

FIGS. 11A and 11B are diagrams illustrating a perspective view of the single core electrical cable in which aspects of technology may be employed;

FIG. 12A is a diagram illustrating a manufacturing system for a single core electrical cable in which aspects of the technology may be practiced; and

FIG. 12B is a diagram illustrating an extrusion die used in the manufacturing system for a single core electrical cable in which aspects of the technology may be practiced.

In the drawings, similar reference numerals refer to similar parts throughout the drawings unless otherwise specified. These drawings are not necessarily drawn to scale.

### DETAILED DESCRIPTION

Existing jackets, while providing protection, may struggle with efficient heat dissipation in many applications. As such, the conductor of an electrical cable may be able to carry less current due to inefficient heat dissipation properties. In light of the foregoing, there is a need for an improved jacket technology. The disclosed embodiments provide jacket structures for electrical cables that can provide improved thermal efficiency and heat dissipation properties.

The specification and accompanying drawings disclose one or more exemplary embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

It is noted that any section/subsection headings provided herein are not intended to be limiting. Any embodiments described throughout this specification, and disclosed in any section/subsection may be combined with any other embodiments described in the same section/subsection and/or a different section/subsection in any manner.

As used herein, a “single core electrical cable” may refer to a structure having a single conductor encased in a single jacket of non-conductive material. For example, a single core electrical cable may consist of just one conductor (or core) enclosed by insulation and a jacket (or protective sheathing). The conductor can be made, for example, of a metal material, such as copper or aluminum. The conductor may be solid or stranded. The jacket is normally made of non-conductive material such as a plastic material (e.g., polyvinyl chloride (PVC)), rubber, Teflon or countless other materials depending on the application. Single core electrical cables are commonly used for applications where only one electrical path is required, such as, in connecting equipment or devices to a power source, in electrical circuits within devices, in building wiring, and in various other applications where a single path of current is required. A “solid” single core electrical cable consists of a single solid conductor. A “stranded” single core electrical cable is made up of multiple thin strands of wire twisted together.

As used herein, a “multicore electrical cable” may refer to a structure having a group of two or more insulated conductors encased in a single jacket. For example, a multicore electrical cable may contain multiple conductors (also referred to as cores) within a single outer jacket (or protective sheathing). Each conductor or core may be individually insulated, and the entire assembly may be enclosed in an outer jacket for additional protection. For instance, the multicore electrical cable may include multiple insulated conductors, and an additional outer sheath or jacket for further protection. The conductors within a cable may also be solid or stranded. As such, an electrical cable may include multiple conductors (or wires) bundled together. Multicore electrical cables are used in applications where multiple circuits or signals need to be transmitted simultaneously, reducing the need for multiple individual cables. They are commonly seen in control systems, data transmission, communication systems, and complex machinery where multiple connections are needed in a compact and organized way. For instance, multicore electrical cables can be used to connect electrical devices, transmit power or data over distances, and in applications requiring multiple conductors, such as those used in power distribution, telecommunications, and networking applications. For instance, as one example, “power cables” may be used to transmit electrical power (e.g., may carry high voltages and are often used in power distribution networks). As another example, “coaxial cables” that include have a central conductor, insulating layer, shielding, and an outer jacket may be used for high-frequency signal transmission. In yet another example, “twisted pair cables” have pairs of insulated wires twisted together to reduce electromagnetic interference.

Jackets may have a variety of different shapes and may be made of many different materials and characteristics. With respect to shape, for example, many conventional jackets that are used with electrical cables typically have a “round” jacket with a cylindrical shape that surrounds one or more conductors (e.g., single core electrical cables and multicore electrical cables). However, the shape of a jacket may vary. In addition to “round jackets,” “flat” and “oval” jackets are also used depending on the application. A “flat” jacket may be shaped to have a rectangular or elliptical in cross-section. Flat jackets may be used, for example, in ribbon cables and certain types of flexible or parallel conductor cables. They are easy to route in tight spaces, may be more flexible, and often used in electronics and computer connections. An “oval” jacket may be shaped to have an elliptical in cross-section. Oval jackets may be used, for example, in specialized cables where space constraints are critical. They combine some benefits of both round and flat jackets, offering a balance between flexibility and compactness.

The choice of shape and material for the jacket is influenced by the need for mechanical protection, environmental resistance, flexibility, ease of installation among other considerations. Materials and characteristics of the jackets that are described herein may vary depending on a number of variables and factors. While common materials for jackets include PVC, polyethylene, rubber, Teflon, and other specialized polymers, it should be appreciated that the materials for jackets may include any material that is capable of providing an insulating function. The material choice affects the jacket's resistance to abrasion, chemicals, UV light, and extreme temperatures. Some materials and shapes are chosen to enhance flexibility, making it easier to bend and route through complex pathways. The thickness of the jacket may vary depending on the application, with thicker jackets providing more protection but potentially reducing flexibility.

Prior to describing exemplary embodiments that incorporate the features of the present disclosure, a discussion of concepts that are applicable to the exemplary embodiments will be provided.

The jacket is an important component of an electrical cable that provides several important functions. The jacket provides insulation to conductor(s) inside can prevent electrical current from escaping and protect against short circuits and electrical shocks. The jacket shields inner conductors from physical damage, such as cuts, abrasions, and impacts, which may compromise the integrity of a cable and lead to electrical failures. Further, the jacket protects the inner conductors from environmental factors such as moisture, chemicals, and UV radiation, which may degrade the performance and longevity of a cable. Additionally, depending on the application, the jacket may provide the necessary flexibility to withstand bending and twisting without cracking or breaking.

Conventional jackets typically have an outer surface that is relatively smooth and uniform as possible with minimal irregularities or variations to make the outer surface as substantially even as possible such that it has no bumps, ridges, or variations. The outer surface is normally designed this way for several practical, performance, and even safety-related reasons. For example, a smooth outer surface helps optimize things such as ease of installation and handling, durability, while reducing the likelihood of weak spots that could compromise underlying insulation.

Conventional jackets may fail to adequately manage heat, leading to potential overheating, reduced efficiency, and increased risk of failure in high-power applications. There is often a tradeoff between flexibility and mechanical protection. Designs that offer high flexibility may lack sufficient strength, while those that are robust may be too rigid for certain applications. Advanced designs that address these issues tend to be complex and costly, hindering their widespread use.

In accordance with the disclosed embodiments, the electrical cable includes the jacket that surrounds a conductor. The jacket has an inner surface and an outer surface. The jacket has features designed to give it texture or varying thickness for strength, thermal management, or other functional reasons. In one embodiment, the inner surface may be relatively uniform along its entire length and may have no bumps, ridges, or variations. By contrast, the outer surface is modified such that it includes surface variations, such as ridges, grooves, bumps or other textured patterns. These surface variations are intentionally introduced to make the outer surface uneven and non-uniform to enhance heat dissipation characteristics of the jacket relative to conventional jackets. Regardless of the implementation, these outer surface modifications are designed to increase the effective surface area of the outer jacket, promoting better thermal exchange with the surrounding environment. Stated differently, the intentional surface variations formed in the outer surface of the jacket can provide a heat-dissipative surface design that creates additional surface area, allowing heat to dissipate more efficiently compared to a jacket having a smooth outer surface. This enhanced thermal exchange surface may be particularly beneficial in high-power applications where cables generate significant heat.

In some embodiments, these intentional surface variations may be referred to as projections. For example, the outer surface may include projections that are designed to provide improved thermal efficiency and heat dissipation properties. The projections may be implemented in various ways, such as, ridges, waves, bumps, and/or dips along the outer surface such that the outer surface is intentionally non-uniform, uneven, unsmooth and/or has a non-linear circumference that varies to provide improved heat dissipation properties. The irregularities of the projections may be subtle, or more pronounced depending on the desired thermal characteristics.

For instance, in some embodiments, the jacket has a ribbed outer surface including a plurality of ribs extending outwards from an outer circumferential surface of the conductor, thereby increasing an outer surface area of the electrical cable and increasing a thermal transfer coefficient of the electrical cable. Thus, the conductor may be able to carry more current due to the increase of the thermal transfer area on the jacket hence reducing the weight, size, and cost of the electrical cable. The jacket may be adapted to have an interlocking design that engages with other jackets to interlock two or more conductors to improve mechanical strength and reduce packaging space. Further, the jacket is designed to improve ampacity and flexibility.

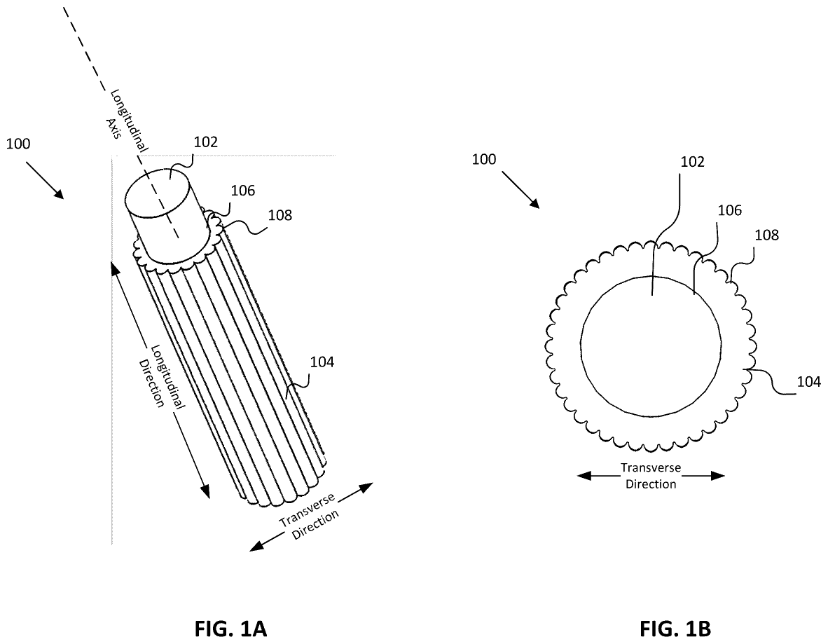

Prior to describing technologies for electrical cables with a jacket having a ribbed outer surface with reference to FIGS. 1A-12B, the following definitions are provided to promote clarity and consistency in the description of the embodiments disclosed herein. These definitions are not intended to limit the scope of the claims unless explicitly recited therein. To the extent a term defined below is used in the singular or plural form in the specification or claims, such usage is intended to include both singular and plural forms unless the context clearly dictates otherwise.

### Cable Geometry and Reference Directions

Longitudinal Axis: As used herein, the term “longitudinal axis” may refer to the primary axis that extends through the center of the electrical cable in the direction of its intended installation or use. The longitudinal axis defines the principal direction of cable extension and serves as the reference orientation for determining whether a structural feature is longitudinal, axial, radial, circumferential, helical, or otherwise oriented with respect to the cable.

Length: As used herein, the term “length” may refer to the dimension of the electrical cable measured parallel to the longitudinal axis. Unless otherwise indicated, any feature described as extending along the “length,” “in the longitudinal direction,” or “axially” is aligned substantially parallel to the longitudinal axis.

Cross-Section: As used herein, the term “cross-section” may refer to a two-dimensional geometric profile obtained by sectioning the cable along a plane that is perpendicular to the longitudinal axis. The cross-section defines the radial configuration of the cable and may be circular, non-circular, uniform, non-uniform, or otherwise shaped depending on the particular embodiments described.

Circumference: As used herein, “circumference” may refer to the perimeter of the cross-section of a component of the electrical cable, including but not limited to a conductor, insulating layer, or jacket. The circumference may be linear, non-linear, smooth, or non-uniform based on the presence or absence of surface features.

Diameter: As used herein, the term “diameter” may refer to the distance across a cross-section measured through the geometric center of the component. For circular cross-sections, the diameter is the conventional circular diameter. For non-circular cross-sections, diameter may refer to an effective or equivalent diameter used for reference or comparative purposes.

### Surface Features of the Jacket

Surface Features: As used herein, the term “surface features” may refer to any structural variations formed on or in the outer surface of a jacket, including but not limited to projections, ribs, ridges, fins, grooves, channels, recesses, undulations, or combinations thereof. Surface features may be provided to modify thermal, mechanical, environmental, or electrical performance characteristics of the cable.

Longitudinal Projections: As used herein, “longitudinal projections” are surface features extending outward from the outer surface of the jacket in a direction that is substantially parallel to the longitudinal axis of the cable. Longitudinal projections may extend continuously or discontinuously along the length of the cable and may be uniform or non-uniform in shape or size.

Longitudinal Channels: As used herein, the term “longitudinal channels” may refer to elongated recesses or valleys formed between adjacent longitudinal projections. Each longitudinal channel extends in a direction substantially parallel to the longitudinal axis and defines a path or space that may facilitate airflow, reduce contact area with supporting surfaces, or improve thermal transfer from the cable.

Longitudinal Ribs: As used herein, “longitudinal ribs” are a subset of longitudinal projections comprising elongated raised structures formed on the outer surface of the jacket. Each longitudinal rib extends in a direction substantially parallel to the longitudinal axis and protrudes radially outward relative to adjacent surface regions. Ribs may be continuous, segmented, helical with an axial component, or otherwise shaped depending on the embodiment.

Longitudinal Ridges: As used herein, the term “longitudinal ridges” may refer to the outwardmost crest, peak, or apex of a longitudinal rib. A ridge defines the portion of the rib having the maximum radial extension measured from the underlying surface of the jacket and extends substantially parallel to the longitudinal axis.

### Cross-Sectional Shapes of Ribs and Projections

When viewed in a cross-sectional plane perpendicular to the longitudinal axis, a longitudinal rib or projection may exhibit any of a variety of shapes. The following non-limiting definitions describe common shapes referenced herein.

Semi-Circular Shape: As used herein, a “semi-circular shape” may refer to a rib or projection having a curved, arcuate exterior profile approximating a portion of a circle or arc. Such a shape may provide a smooth outer contour with gradual transitions to adjacent surface regions.

Triangular Shape: As used herein, a “triangular shape” may refer to a rib or projection having a cross-section defined by two sloped or straight sides meeting at an apex, thereby forming a triangular profile. The apex corresponds to the point of maximum radial extension.

Trapezoidal Shape: As used herein, a “trapezoidal shape” may refer to a rib or projection having a cross-section with a generally flat or rounded top surface and sloped or vertical sides that expand toward the base, such that the resulting profile approximates a trapezoid. Trapezoidal ribs may provide increased mechanical robustness due to their wider bases.

Saw Tooth Shape: As used herein, a “saw tooth shape” may refer to a rib or projection having an asymmetric, serrated, or angled cross-section resembling the tooth of a saw blade. One side of the rib may be steeply angled or nearly vertical, while the opposite side may be oblique or more gradually sloped. Such profiles may influence airflow direction, mechanical gripping, or engagement with adjacent surfaces.

Having given this description of the jacket that can be applied within the context of the present disclosure, technologies will now be described for electrical cables with a jacket having a ribbed outer surface will now be described with reference to FIGS. 1A-12B.

FIGS. 1A and 1B are diagrams illustrating a perspective view and a sectional view of a single core electrical cable 100 in which aspects of the technology may be employed. The single core electrical cable 100 may include a conductor 102 surrounded by the jacket 104. In an embodiment, the conductor 102 may correspond to a single conductor and the jacket 104 may correspond to a single jacket. As used herein, the phrase “surrounded by” refers to an inner layer generally being encased by an outer layer. However, it is understood that an inner layer may be “surrounded by” an outer layer without the inner layer being immediately adjacent to the outer layer. The term “surrounded by” thus allows for the possibility of intervening layers.

The conductor 102 has a cross-sectional profile and an outer surface with a circumference. The conductor 102 may be positioned at the core of the single core electrical cable 100 and may be configured to carry a range of electrical current and/or RF/electronic digital signals. The conductor 102 may be formed from copper, aluminum, silver, copper-clad aluminum (CCA), copper-clad steel (CCS), or silver-coated copper clad steel (SCCCS), although other conductive materials are also possible. For example, the conductor 102 may be formed from any type of conductive metal or alloy. The conductor 102 may have configurations such as clad, solid, stranded, corrugated, plated, hollow, or the like.

The jacket 104 has an inner surface 106 and a ribbed outer surface 108. The inner surface 106 has a first cross-sectional profile that is substantially uniform with respect to the cross-sectional profile of the conductor 102. The ribbed outer surface 108 has a second cross-sectional profile that is substantially non-uniform with respect to the cross-sectional profile of the conductor 102 and the first cross-sectional profile. The second cross-sectional profile of the ribbed outer surface 108 of the jacket 104 has a non-linear circumference defined by projections and valleys (also referred to as “channels” herein) between the projections. The projections may increase thermal transfer coefficient of the jacket 104 and increase thermal transfer from the conductor 102. The ribbed outer surface 108 of the jacket 104 includes a plurality of ribs extending outwards from the inner surface 106 such that the second cross-sectional profile of the ribbed outer surface 108 of the jacket 104 has a non-linear circumference with respect to the circumference of the conductor 102.

It will be apparent to a person skilled in the art that the ribbed outer surface 108 with the plurality of ribs may correspond to one of a fluted outer surface with protrusions, a bloomed outer surface with petals, a finned outer surface with fins, and the like, without deviating from the scope of the present disclosure.

In one embodiment, the plurality of ribs forms longitudinal ridges running parallel along length of the conductor 102. In another embodiment, the plurality of ribs form one of helical ridges and circular ridges running along length of the conductor 102. It will be apparent to a person skilled in the art that the plurality of ribs may forms ridges in any suitable orientation, without deviating from the scope of the present disclosure. A shape of each of the plurality of ribs may correspond to at least one of a semi-circular shape, a triangular shape, a trapezoidal shape, a saw tooth shape, and any combination thereof. In one example, the shape of each of the plurality of ribs corresponds to a semi-circular shape. It will be apparent to a person skilled in the art that the shape of each of the plurality of ribs may correspond to any suitable shape which increases the outer surface area of the single core electrical cable 100, without deviating from the scope of the present disclosure.

The single core electrical cable 100 with the ribbed outer surface 108 of the jacket 104 may be able to carry more current due to increase of the thermal transfer area, hence reducing the weight, size, and cost of the single core electrical cable 100 and improve heat dissipation, ampacity, and flexibility. Ampacity is defined as the maximum current, in amperes, that a conductor, such as the conductor 102, may carry continuously under the conditions of use without exceeding a temperature rating of the corresponding conductor. The ampacity of the conductor depends on an ability of the conductor to dissipate heat without damage to the conductor or the insulation, e.g., the jacket 104, of the conductor. Generally, a conductor may dissipate heat though convection, conduction, or radiation which are directly proportional to an area available for heat dissipation. Thus, greater surface area for heat dissipation increases the ampacity of the conductor.

The jacket 104 may shield the conductor 102 from physical damage due to abrasion and other mechanical stresses. The jacket 104 may serve to protect the conductor 102 from external contaminants, such as dust, moisture, and oils. The jacket 104 may enhance the overall insulation of the single core electrical cable 100 to prevent electrical shocks and short circuits. Thus, with the ribbed outer surface 108 of the jacket 104, under the same conductor cross section and an outer diameter of the single core electrical cable 100, the conductor 102 may carry more current than the conventional single core electrical cable.

The jacket 104 may be formed from a variety of materials including, but not limited to, polyethylene (PE), high-density polyethylene (HDPE), low-density polyethylene (LDPE), linear low-density polyethylene (LLDPE), rubberized polyvinyl chloride (PVC), or some combination thereof. The actual material used in the formation of the jacket 104 may be indicated by the particular application/environment contemplated.

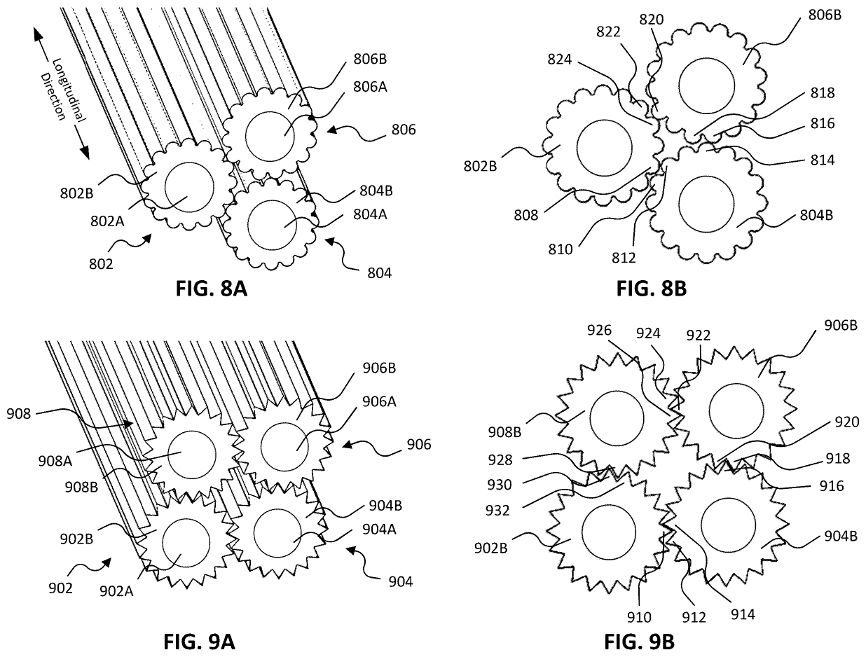

In one embodiment, the jacket 104 may be coated over the conductor 102 by way of an extrusion process using an extrusion die (shown later in FIG. 8) having a ribbed inner surface. A shape of the ribbed inner surface of the extrusion die may be complimentary to a shape of the ribbed outer surface 108 of the jacket 104.

The single core electrical cable 100 may have applications in industries where efficient heat management and mechanical protection are important, such as in automotive, aerospace, and high-performance electronics applications. In an embodiment, the single core electrical cable 100 may be used in the aerospace industries including spacecraft, launch vehicles, satellites, and other space-related components.

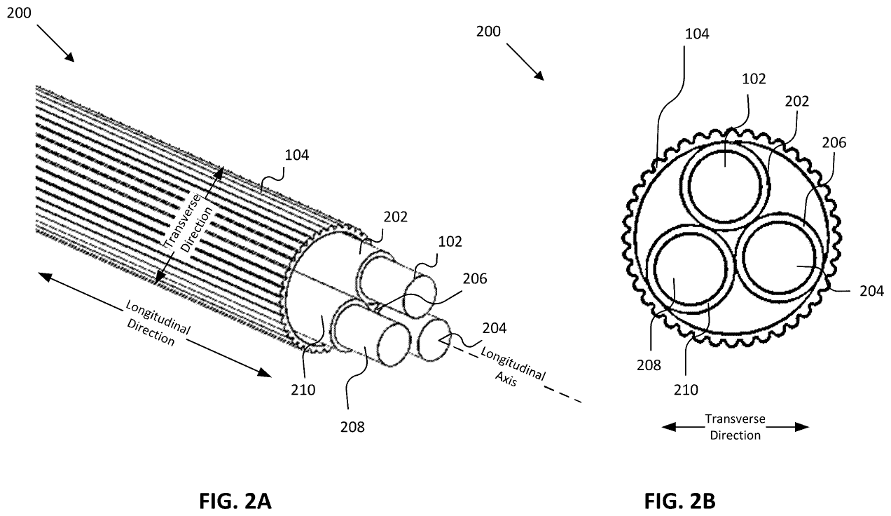

FIGS. 2A and 2B are diagrams illustrating a perspective view and a sectional view of a multicore electrical cable 200 in which aspects of the technology may be employed. The multicore electrical cable 200 may include the first conductor 102, the first jacket 104, a second jacket 202, a second conductor 204, a third jacket 206, a third conductor 208, and a fourth jacket 210. The first through third conductors 102, 204, and 208 may correspond to a first set of conductors. In an embodiment, the first set of conductors are insulated by corresponding jackets such as the first through third jackets 104, 202, and 206. The second jacket 202 surrounds the first conductor 102. The second jacket 202 has an inner surface and an outer surface. The inner surface has a first cross-sectional profile that is substantially uniform with respect to the cross-sectional profile of the first conductor 102. The outer surface has a second cross-sectional profile that is substantially uniform with respect to the cross-sectional profile of the first conductor 102 and the first cross-sectional profile.

The second conductor 204 has a cross-sectional profile and an outer surface with a circumference. The third jacket 206 surrounds the second conductor 204. The third jacket 206 has an inner surface and an outer surface. The inner surface may have a first cross-sectional profile that is substantially uniform with respect to the cross-sectional profile of the second conductor 204. The outer surface has a second cross-sectional profile that is substantially uniform with respect to the cross-sectional profile of the second conductor 204 and the first cross-sectional profile.

The fourth jacket 210 surrounds the third conductor 208. The fourth jacket 210 has an inner surface and an outer surface. The inner surface has a first cross-sectional profile that is substantially uniform with respect to the cross-sectional profile of the third conductor 208. The outer surface has a second cross-sectional profile that is substantially uniform with respect to the cross-sectional profile of the third conductor 208 and the first cross-sectional profile. In this embodiment, the first jacket 104 collectively surrounds the second jacket 202, the third jacket 206, and the fourth jacket 210 such that the first conductor 102 surrounded by the second jacket 202, the second conductor 204 surrounded by the third jacket 206, and the third conductor 208 surrounded by the second jacket 202 are disposed within the first jacket 104.

In this embodiment, the first set of conductors, e.g., the first conductor 102 surrounded by the second jacket 202, the second conductor 204 surrounded by the third jacket 206, and the third conductor 208 surrounded by the second jacket 202, has a cross-sectional profile and an outer surface with a circumference. The first jacket 104 surrounds the first set of conductors. The first jacket 104 includes an inner surface having a first cross-sectional profile that is substantially uniform with respect to the cross-sectional profile of the first set of conductors. The first jacket 104 further includes an outer surface having a second cross-sectional profile that is substantially non-uniform with respect to the cross-sectional profile of the first set of conductors and the first cross-sectional profile. The second cross-sectional profile of the outer surface of the first jacket 104 has a non-linear circumference defined by projections and valleys between the projections. The projections increase thermal transfer coefficient of the first jacket 104 and increase thermal transfer from the first set of conductors. The outer surface of the first jacket 104 includes a ribbed outer surface including a plurality of ribs extending outwards from the inner surface such that the second cross-sectional profile of the ribbed outer surface has a non-linear circumference with respect to the circumference of the first set of conductors.

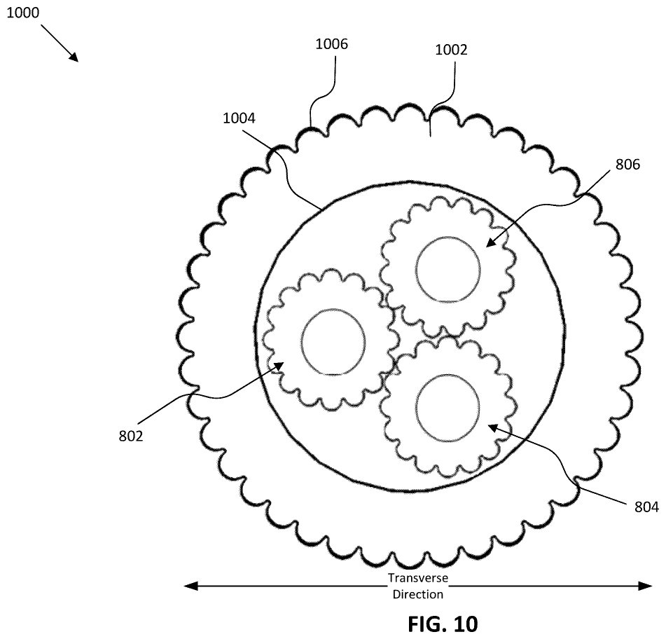

It will be apparent to a person skilled in the art that the second conductor 204 and the third conductor 208 may be structurally and functionally similar to the conductor 102 as described in FIGS. 1A and 1B. In an embodiment, the second jacket 202, the third jacket 206, and the fourth jacket 210 have smooth outer surfaces having round shapes as shown in FIGS. 2A and 2B. In another embodiment, the second jacket 202, the third jacket 206, and the fourth jacket 210 may have ribbed outer surfaces including plurality of ribs explained in detail in conjunction with FIG. 10.

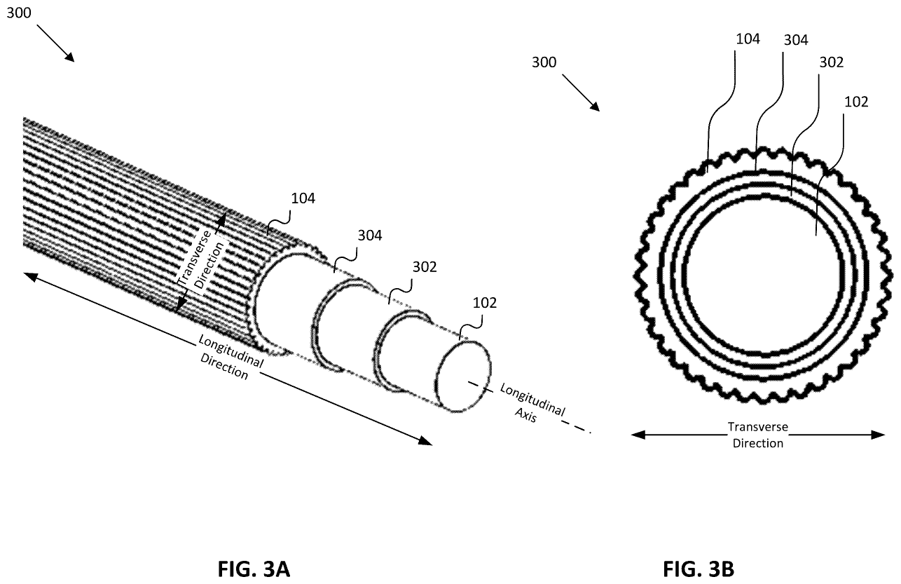

FIGS. 3A and 3B are diagrams illustrating a perspective view and a sectional view of a single core electrical cable 300 in which aspects of the technology may be employed. In an embodiment, the single core electrical cable 300 may correspond to a coaxial cable. The single core electrical cable 300 includes the conductor 102, an insulator 302 surrounding the conductor 102, a shielding 304 disposed on an external periphery of the insulator 302, and the jacket 104 surrounding the shielding 304. The insulator 302 and the shielding 304 are disposed between the conductor 102 and the jacket 104.

The insulator 302 separates the conductor 102 from the shielding 304 to maintain impedance of the single core electrical cable 300, preventing short circuits, and ensure efficient signal transmission. The insulator 302 may minimize signal loss and distortion by providing a stable medium through which an electromagnetic wave may propagate. The insulator 302 may be formed by using various materials including, but not limited to, polyethylene (PE), foamed polyethylene, Teflon (PTFE), polyvinyl chloride (PVC), polystyrene, or some combination thereof. The actual material used in the formation of the insulator 302 may be indicated by the particular application/environment contemplated.

The shielding 304 (or sheathing) is an important layer designed to protect signal integrity by preventing external electromagnetic interference (EMI) and radio frequency interference (RFI). The shielding 304 may protect the conductor 102 from external electromagnetic fields that may cause noise and signal degradation. Further, the shielding 304 may prevent the signals carried by the conductor 102 from leaking and interfering with nearby electronic devices. Various types of shielding 304 may include, but not limited to, braided shield, foil shield, combination shield (foil +braided), and quad shield.

It will be apparent to a person skilled in the art that similar to the single core electrical cable 300, in an alternate embodiment, the multicore electrical cable 200 may also include the insulator 302 and the shielding 304. In this embodiment, the insulator 302 may surround the first set of conductors and the shielding 304 may be disposed on an external periphery of the insulator 302. The insulator 302 and the shielding 304 may be disposed between the first set of conductors and the first jacket 104. The first jacket 104 may surround the shielding 304.

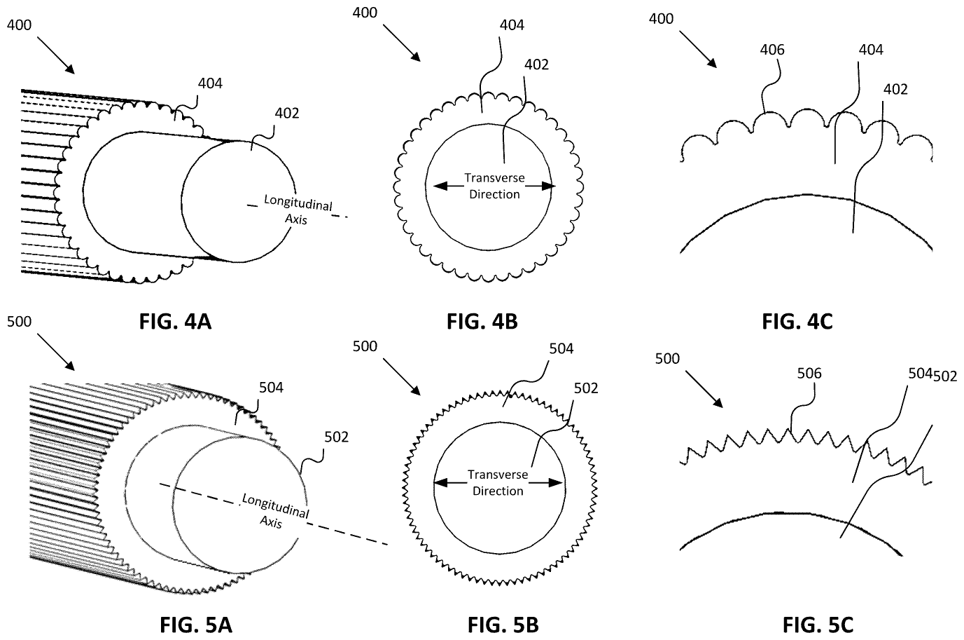

FIGS. 4A-4C are diagrams illustrating a perspective view, a sectional view, and a zoomed in view of the single core electrical cable 400 in which aspects of the technology may be employed. The single core electrical cable 400 includes a conductor 402 and a jacket 404 surrounding the conductor 402. The conductor 402 has a cross-sectional profile and an outer surface with a circumference. The jacket 404 has an inner surface and a ribbed outer surface. The inner surface has a first cross-sectional profile that is substantially uniform with respect to the cross-sectional profile of the conductor 402. The ribbed outer surface has a second cross-sectional profile that is substantially non-uniform with respect to the cross-sectional profile of the conductor 402 and the first cross-sectional profile. The ribbed outer surface of the jacket 404 includes a plurality of ribs, such as rib 406, extending outwards from the inner surface such that the second cross-sectional profile of the ribbed outer surface of the jacket 404 has a non-linear circumference with respect to the circumference of the conductor 402.

Each of the plurality of ribs, such as the rib 406, may have a semi-circular shape as shown in the FIG. 4C. In one embodiment, the plurality of ribs may have no gaps in between two consecutive ribs of the plurality of ribs. In another embodiment, the plurality of ribs are positioned equidistant to each other having equal gap in between two consecutive ribs of the plurality of ribs. In yet another embodiment, the plurality of ribs may be positioned non-equidistant to each other having unequal gap in between two consecutive ribs of the plurality of ribs. It will be apparent to a person skilled in the art that in alternate embodiment, similar to the single core electrical cable 400, a multicore electrical cable having a set of conductors and a jacket may have a ribbed outer surface of the jacket having a plurality of ribs of semi-circular shapes.

FIGS. 5A-5C are diagrams illustrating a perspective view, a sectional view, and a zoomed in view of the single core electrical cable 500 in which aspects of the technology may be employed. The single core electrical cable 500 includes a conductor 502 and a jacket 504 surrounding the conductor 502. The conductor 502 has a cross-sectional profile and an outer surface with a circumference. The jacket 504 has an inner surface and a ribbed outer surface. The inner surface has a first cross-sectional profile that is substantially uniform with respect to the cross-sectional profile of the conductor 502. The ribbed outer surface has a second cross-sectional profile that is substantially non-uniform with respect to the cross-sectional profile of the conductor 502 and the first cross-sectional profile. The ribbed outer surface of the jacket 504 includes a plurality of ribs, such as rib 506, extending outwards from the inner surface such that the second cross-sectional profile of the ribbed outer surface of the jacket 504 has a non-linear circumference with respect to the circumference of the conductor 502.

Each of the plurality of ribs, such as the rib 506, may have a triangular shape (e.g., fin like shape) as shown in the FIG. 5C. In one embodiment, the plurality of ribs have no gaps in between two consecutive ribs of the plurality of ribs. In another embodiment, the plurality of ribs are positioned equidistant to each other having equal gap in between two consecutive ribs of the plurality of ribs. In yet another embodiment, the plurality of ribs are positioned non-equidistant to each other having unequal gap in between two consecutive ribs of the plurality of ribs. It will be apparent to a person skilled in the art that in alternate embodiment, similar to the single core electrical cable 500, a multicore electrical cable having a set of conductors and a jacket may have a ribbed outer surface of the jacket having a plurality of ribs of triangular shapes.

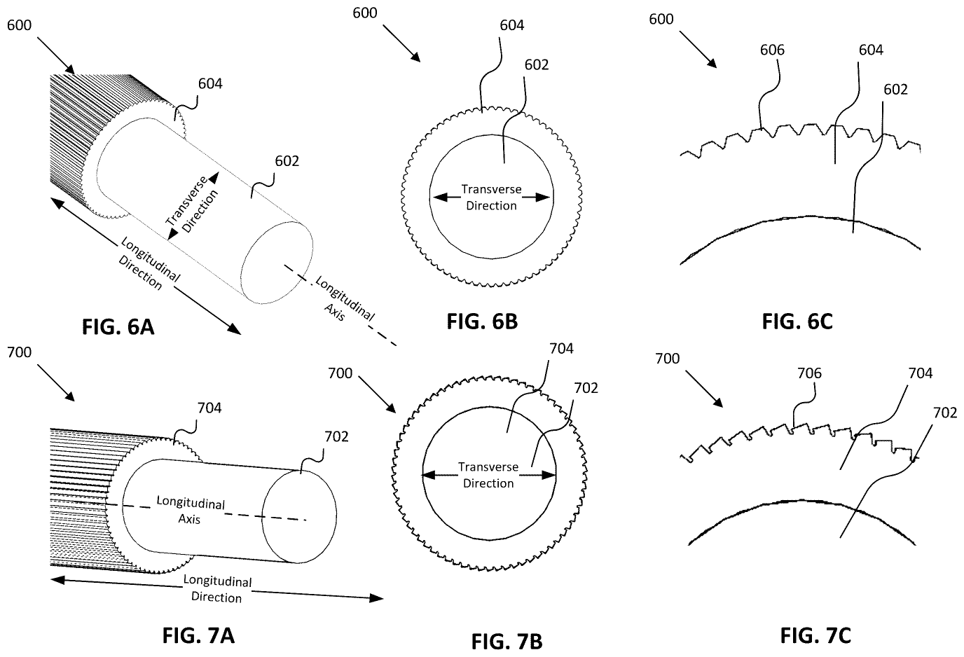

FIGS. 6A-6C are diagrams illustrating a perspective view, a sectional view, and a zoomed in view of the single core electrical cable 600 in which aspects of the technology may be employed. The single core electrical cable 600 includes a conductor 602 and a jacket 604 surrounding the conductor 602. The conductor 602 has a cross-sectional profile and an outer surface with a circumference. The jacket 604 has an inner surface and a ribbed outer surface. The inner surface has a first cross-sectional profile that is substantially uniform with respect to the cross-sectional profile of the conductor 602. The ribbed outer surface has a second cross-sectional profile that is substantially non-uniform with respect to the cross-sectional profile of the conductor 602 and the first cross-sectional profile. The ribbed outer surface of the jacket 604 includes a plurality of ribs, such as rib 606, extending outwards from the inner surface such that the second cross-sectional profile of the ribbed outer surface of the jacket 604 has a non-linear circumference with respect to the circumference of the conductor 602.

Each of the plurality of ribs, such as the rib 606, may have a trapezoidal shape (e.g., gear like shape) as shown in the FIG. 6C. In one embodiment, the plurality of ribs may have no gaps in between two consecutive ribs of the plurality of ribs. In another embodiment, the plurality of ribs may be positioned equidistant to each other having equal gap in between two consecutive ribs of the plurality of ribs. In yet another embodiment, the plurality of ribs may be positioned non-equidistant to each other having unequal gap in between two consecutive ribs of the plurality of ribs. It will be apparent to a person skilled in the art that in alternate embodiment, similar to the single core electrical cable 600, a multicore electrical cable having a set of conductors and a jacket may have a ribbed outer surface of the jacket having a plurality of ribs of trapezoidal shapes.

FIGS. 7A-7C are diagrams illustrating a perspective view, a sectional view, and a zoomed in view of the single core electrical cable 700 in which aspects of the technology may be employed. The single core electrical cable 700 includes a conductor 702 and a jacket 704 surrounding the conductor 702. The conductor 702 has a cross-sectional profile and an outer surface with a circumference. The jacket 704 has an inner surface and a ribbed outer surface. The inner surface has a first cross-sectional profile that is substantially uniform with respect to the cross-sectional profile of the conductor 702. The ribbed outer surface has a second cross-sectional profile that is substantially non-uniform with respect to the cross-sectional profile of the conductor 702 and the first cross-sectional profile. The ribbed outer surface of the jacket 704 includes a plurality of ribs, such as rib 706, extending outwards from the inner surface such that the second cross-sectional profile of the ribbed outer surface of the jacket 704 has a non-linear circumference with respect to the circumference of the conductor 702.

Each of the plurality of ribs, such as the rib 706, may have a saw tooth shape as shown in the FIG. 7C. In one embodiment, the plurality of ribs are positioned equidistant to each other having equal gap in between two consecutive ribs of the plurality of ribs. In another embodiment, the plurality of ribs have no gaps in between two consecutive ribs of the plurality of ribs. In yet another embodiment, the plurality of ribs are positioned non-equidistant to each other having unequal gap in between two consecutive ribs of the plurality of ribs. It will be apparent to a person skilled in the art that in alternate embodiment, similar to the single core electrical cable 700, a multicore electrical cable having a set of conductors and a jacket may have a ribbed outer surface of the jacket having a plurality of ribs of saw tooth shapes.

FIGS. 8A and 8B are diagrams illustrating a perspective view and a sectional view of interlocking between single core electrical cables in which aspects of technology may be employed. Single core electrical cables 802, 804, and 806 have conductors 802A, 804A, and 806A surrounded by jackets 802B, 804B, and 806B, respectively. It will be apparent to a person skilled in the art that the single core electrical cables 802, 804, and 806 may be structurally and functionally similar to the single core electrical cable 400 as described in FIGS. 4A-4C . Each of the jackets 802B, 804B, and 806B include ribbed outer surface having a plurality of ribs of semi-circular shape. The plurality of ribs of the ribbed outer surface of the jackets 802B, 804B, and 806B are adapted to engage with the plurality of ribs of each other to interlock the conductors 802A, 804A, and 806A.

In one embodiment, a rib 808 of the plurality of ribs of the jacket 802B is adapted to engage between ribs 810 and 812 of the plurality of ribs of the jacket 804B. Similarly, a rib 814 of the plurality of ribs of the jacket 804B is adapted to engage between ribs 816 and 818 of the plurality of ribs of the jacket 806B and a rib 820 of the plurality of ribs of the jacket 806B is adapted to engage between ribs 822 and 824 of the plurality of ribs of the jacket 802B. The single core electrical cables 802, 804, and 806 are thus interlocked by way of interlocking of the plurality of ribs of the jackets 802B, 804B, and 806B. The interlocking of the single core electrical cables 802, 804, and 806 improves mechanical strength and packaging space. It will be apparent to a person skilled in the art that in alternate embodiment, similar to the single core electrical cables 802, 804, and 806, first through third multicore electrical cables having first through third sets of conductors surrounded by first through third jackets, respectively, may be interlocked by way of plurality of ribs of the first through third jackets.

FIGS. 9A and 9B are diagrams illustrating a perspective view and a sectional view of interlocking between single core electrical cables in which aspects of technology may be employed. Single core electrical cables 902, 904, 906, and 908 have conductors 902A, 904A, 906A, and 908A surrounded by jackets 902B, 904B, 906B, and 908B, respectively. It will be apparent to a person skilled in the art that the single core electrical cables 902, 904, 906, and 908 may be structurally and functionally similar to the single core electrical cable 500 as described in FIGS. 5A-5C . Each of the jackets 902B, 904B, 906B, and 908B include ribbed outer surface having a plurality of ribs of triangular shape. The plurality of ribs of the ribbed outer surface of the jackets 902B, 904B, 906B, and 908B are adapted to engage with the plurality of ribs of each other to interlock the conductors 902A, 904A, 906A, and 908A.

In one embodiment, a rib 910 of the plurality of ribs of the jacket 902B is adapted to engage between ribs 912 and 914 of the plurality of ribs of the jacket 904B. Similarly, a rib 916 of the plurality of ribs of the jacket 904B is adapted to engage between ribs 918 and 920 of the plurality of ribs of the jacket 906B, a rib 922 of the plurality of ribs of the jacket 906B is adapted to engage between ribs 924 and 926 of the plurality of ribs of the jacket 908B, and a rib 928 of the plurality of ribs of the jacket 908B is adapted to engage between ribs 930 and 932 of the plurality of ribs of the jacket 902B. The single core electrical cables 902, 904, 906, and 908 are thus interlocked by way of interlocking of the plurality of ribs of the jackets 902B, 904B, 906B, and 908B. The interlocking of the single core electrical cables 902, 904, 906, and 908 improves mechanical strength and packaging space.

FIG. 10 is a diagram illustrating a multicore electrical cable 1000 having the multiple single core electrical cables 802, 804, 806 in which aspects of technology may be employed. The multicore electrical cable 1000 includes the single core electrical cables 802, 804, and 806 and a jacket 1002. The single core electrical cables 802, 804, and 806 are interlocked as described in FIGS. 8A and 8B. The jacket 1002 surrounds the interlocked single core electrical cables 802, 804, 806.

The jacket 1002 has an inner surface 1004 and a ribbed outer surface 1006. The inner surface 1004 has a first cross-sectional profile. The ribbed outer surface 1006 has a second cross-sectional profile. The second cross-sectional profile of the ribbed outer surface 1006 has a non-linear circumference defined by projections and valleys between the projections. The projections may increase thermal transfer coefficient of the jacket 1002. The ribbed outer surface 1006 of the jacket 1002 includes a plurality of ribs extending outwards from the inner surface 1004, thereby increasing an outer surface area of the multicore electrical cable 1000 and increasing a thermal coefficient of the multicore electrical cable 1000.

It will be apparent to a person skilled in the art that in alternate embodiment, similar to the single core electrical cables 802, 804, and 806, the multicore electrical cable 1000 may include first through third multicore electrical cables and the jacket 1002. The first through third multicore electrical cables may be interlocked as described in FIGS. 8A and 8B. The jacket 1002 may surround the interlocked first through third multicore electrical cables.

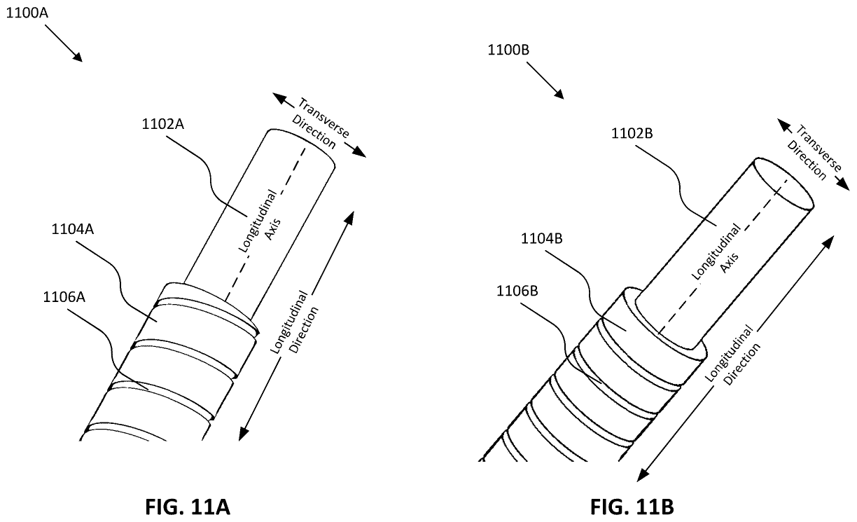

FIGS. 11A and 11B are diagrams illustrating a perspective view of the single core electrical cable 1100A and 1100B with different orientation of the outer surface of jackets in which aspects of technology may be employed. In an embodiment, the single core electrical cable 1100A may include a conductor 1102A and a jacket 1104A that may surround the conductor 1102A. The jacket 1104A may have an inner surface and an outer surface. The outer surface of the jacket 1104A has helical grooves 1106A running along the length of the conductor 1102A that may enhance flexibility, allowing the single core electrical cable 1100A to bend and twist without damaging the jacket 1104A. The helical grooves 1106A of the outer surface of the jacket 1104A improves mechanical protection by distributing stress along helical orientation (spiral orientation) and improves heat dissipation due to increased surface area. In another embodiment, the single core electrical cable 1100B may include a conductor 1102B and a jacket 1104B that may surround the conductor 1102B. The jacket 1104B may have an inner surface and an outer surface. The outer surface of the jacket 1104B has radial grooves 1106B (corrugated pattern) running along the length of the conductor 1102B that may enhance flexibility, allowing the single core electrical cable 1100B to bend and twist without damaging the jacket 1104B. The radial grooves 1106B of the outer surface of the jacket 1104B improves mechanical protection by distributing stress along radial orientation and improves heat dissipation due to increased surface area.

It will be understood by a person skilled in the art that the multicore electrical cables may also employ a similar jacket design as employed by the single core electrical cables 1100A and 1100B, without deviating from the scope of the present disclosure.

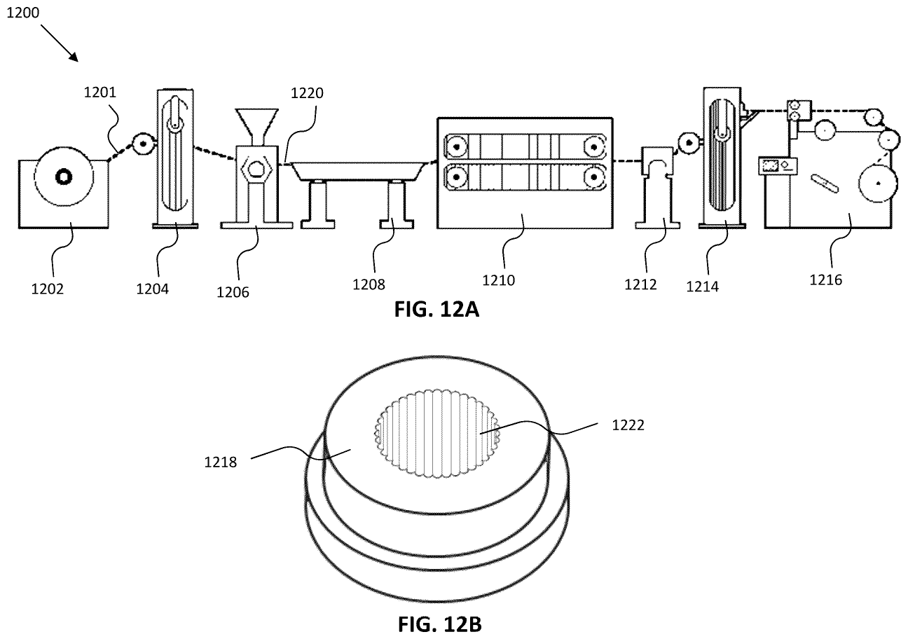

FIG. 12A is a diagram illustrating a manufacturing system 1200 for single core electrical cable 1220 in which aspects of the technology may be practiced. The manufacturing system 1200 may include a feeding device 1202, a tensioning device 1204, an extrusion device 1206, a cooling device 1208, a pulling device 1210, an inspection device 1212, a tensioning device 1214, and a spooling device 1216. The FIG. 12B is a diagram illustrating an extrusion die 1218 used in the manufacturing system 1200 for single core electrical cable 1220 in which aspects of the technology may be practiced.

Referring now to FIG. 12A, the feeding device 1202 may be configured to receive and supply raw materials, such as a conductor 1201, into the manufacturing system 1200. The feeding device 1202 may ensure a continuous and controlled feed to maintain the production process. The tensioning device 1204 may be configured to apply necessary tension to the conductor 1201 as the conductor 1201 moves through the manufacturing system 1200. Proper tension is important to prevent slack or excessive stretching, which may affect the quality of the final product.

Referring now to FIGS. 12A and 12B, the extrusion device 1206 may be configured to coat the conductor 1201 with an insulating material by way of an extrusion process. The extrusion process may involve heating the material and forcing the material through the extrusion die 1218 to form a uniform coating (jacket) around the conductor 1201 and forming the single core electrical cable 1220. In one embodiment, the jacket coated around the conductor 1201 may have an inner surface and a ribbed outer surface including a plurality of ribs extending outwards from an outer circumferential surface of the conductor 1201. The extrusion die 1218 has a ribbed inner surface 1222. A shape of the ribbed inner surface 1222 of the extrusion die is complimentary to a shape of the ribbed outer surface of the jacket of the single core electrical cable 1220.

After extrusion, the single core electrical cable 1220 may be cooled to solidify the insulating material. The cooling device 1208 may be configured to utilize water or air to bring the temperature of the single core electrical cable 1220 down quickly and uniformly. The pulling device 1210 may be configured to pull the single core electrical cable 1220 through the various stages of the manufacturing process ensuring a consistent speed and tension, which is required for maintaining the quality and dimensions of the single core electrical cable 1220. The inspection device 1212 may be configured to check the single core electrical cable 1220 for any defects or inconsistencies. The inspection device 1212 may use various methods, such as visual inspection, electrical testing, or automated sensors, to ensure the single core electrical cable 1220 meets quality standards. The tensioning device 1214 may be configured to ensure the single core electrical cable 1220 maintains the correct tension as the single core electrical cable 1220 moves towards the final stages of production. The spooling device 1216 may be configured to wind the finished single core electrical cable 1220 onto spools or reels for easy handling, storage, and transportation. The spooling device 1216 may ensure that the single core electrical cable 1220 is neatly and tightly wound to prevent tangling or damage.

It will be apparent to a person skilled in the art that, if the raw material fed into the feeding device 1202, e.g., the conductor 1201, is replaced by a set of conductors, the manufacturing system 1200 may form a multicore electrical cable using the similar process as described in FIGS. 12A and 12B for formation of the single core electrical cable 1220, without deviating from the scope of the present disclosure. In one embodiment, each conductor of the set of conductors fed into the feeding device 1202 may be an insulated conductor. In another embodiment, each conductor of the set of conductors fed into the feeding device 1202 may be a non-insulated conductor.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (e.g. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected,” “attached” or “coupled” to another feature or element, it can be directly connected, attached, or coupled to the other feature or element or intervening features or elements may be present. In contrast, when a feature or element is referred to as being “directly connected,” “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly,” “downwardly,” “vertical,” “horizontal,” “lateral,” “transverse,” “longitudinal,” and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an example embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an example embodiment,” “an exemplary embodiment,” or “other embodiments,” or the like, are not necessarily all referring to the same embodiments. References in the specification to “an embodiment,” “one embodiment,” “some embodiments,” “one particular embodiment,” “an example embodiment,” “an exemplary embodiment,” or “other embodiments,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

If this specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

The description and illustration of various embodiments of the disclosure are examples and the disclosure is not limited to the exact details shown or described. While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed is:

1. A multicore electrical cable having a longitudinal axis along the length of the multicore electrical cable, the multicore electrical cable comprising:
a first set of conductors having a cross-sectional profile and an outer surface with a circumference; and
a first jacket surrounding the first set of conductors, the first jacket comprising:
an inner surface having a first cross-sectional profile that is substantially uniform with respect to the cross-sectional profile of the first set of conductors; and
an outer surface having a plurality of surface features extending along the longitudinal axis of the multicore electrical cable, the surface features defining a non-linear circumference configured to enhance thermal dissipation,
the outer surface having a second cross-sectional profile that is substantially non-uniform with respect to the cross-sectional profile of the first set of conductors and the first cross-sectional profile.

2. The multicore electrical cable of claim 1, wherein the plurality of surface features of the outer surface of the first jacket comprise:
a plurality of longitudinal projections extending in a direction parallel to the longitudinal axis, the longitudinal projections defining the non-linear circumference and forming longitudinal channels therebetween, wherein the longitudinal channels are configured to increase convective heat transfer from the first set of conductors,
wherein the second cross-sectional profile of the outer surface has the non-linear circumference defined by the longitudinal projections and the longitudinal channels between the longitudinal projections,
wherein the longitudinal projections and the longitudinal channels extend longitudinally along the length of and parallel to the longitudinal axis of the multicore electrical cable, and
wherein the longitudinal projections increase thermal transfer coefficient of the first jacket and increase thermal transfer from the first set of conductors.

3. The multicore electrical cable of claim 1, wherein the outer surface of the first jacket comprises:
a ribbed outer surface, wherein the plurality of surface features of the ribbed outer surface comprise:
a plurality of longitudinal ribs, wherein each longitudinal rib extends continuously or intermittently along the longitudinal axis and outwards from the inner surface such that the second cross-sectional profile of the ribbed outer surface has a non-linear circumference with respect to the circumference of the first set of conductors, and
wherein the plurality of longitudinal ribs create a plurality of longitudinal channels along the ribbed outer surface.

4. The multicore electrical cable of claim 3, wherein each of the plurality of longitudinal ribs also extend longitudinally along the length of and parallel to the longitudinal axis of the multicore electrical cable, and
wherein the plurality of longitudinal ribs form longitudinal ridges therebetween running parallel along length of the first set of conductors.

5. The multicore electrical cable of claim 3, wherein a shape of each of the plurality of longitudinal ribs corresponds to at least one of a semi-circular shape, a triangular shape, a trapezoidal shape, and a saw tooth shape.

6. The multicore electrical cable of claim 3, wherein each of the plurality of longitudinal ribs extend longitudinally along the length of and parallel to the longitudinal axis of the multicore electrical cable, and
wherein the plurality of longitudinal ribs form one of:
straight longitudinal ridges extending around the multicore electrical cable with a pitch greater than the height, all of which include an axial component of extension; and
helical ridges extending around the multicore electrical cable with a pitch greater than the height, all of which include an axial component of extension.

7. The multicore electrical cable of claim 3, wherein the first jacket is coated over the first set of conductors by way of an extrusion process using an extrusion die having a ribbed inner surface or a fin-forming inner surface, wherein a shape of the ribbed inner surface or the fin-forming inner surface of the extrusion die is complimentary to a shape of the ribbed outer surface of the first jacket.

8. The multicore electrical cable of claim 1, further comprising:
a second jacket surrounding the first set of conductors, the second jacket comprising:
an inner surface having a first cross-sectional profile that is substantially uniform with respect to the cross-sectional profile of the first set of conductors; and
an outer surface having a second cross-sectional profile that is substantially uniform with respect to the cross-sectional profile of the first set of conductors and the first cross-sectional profile of the inner surface of the second jacket;
a second set of conductors having a cross-sectional profile and an outer surface with a circumference; and
a third jacket surrounding the second set of conductors, the third jacket comprising:
an inner surface having a first cross-sectional profile that is substantially uniform with respect to the cross-sectional profile of the second set of conductors; and
an outer surface having a second cross-sectional profile that is substantially uniform with respect to the cross-sectional profile of the second set of conductors and the first cross-sectional profile of the inner surface of the third jacket, wherein the first jacket surrounds the second jacket and the third jacket.

9. The multicore electrical cable of claim 2, further comprising:
a second set of conductors having a cross-sectional profile and an outer surface with a circumference;
a second jacket surrounding the second set of conductors, the second jacket comprising:
an inner surface having a first cross-sectional profile that is substantially uniform with respect to the cross-sectional profile of the second set of conductors; and
an outer surface having a plurality of surface features extending along the longitudinal axis of the multicore electrical cable, the surface features defining a non-linear circumference configured to enhance thermal dissipation, the outer surface having a second cross-sectional profile that is substantially non-uniform with respect to the cross-sectional profile of the second set of conductors and the first cross-sectional profile of the inner surface of the second jacket, wherein the plurality of surface features of the outer surface of the second jacket comprise:
a plurality of longitudinal projections extending in a direction parallel to the longitudinal axis, the longitudinal projections defining the non-linear circumference and forming longitudinal channels therebetween, wherein the longitudinal channels are configured to increase convective heat transfer from the second set of conductors,
wherein the second cross-sectional profile of the outer surface of the second jacket has the non-linear circumference defined by the longitudinal projections and the longitudinal channels between the longitudinal projections, wherein the longitudinal projections and the longitudinal channels extend longitudinally along the length of and parallel to the longitudinal axis of the multicore electrical cable, and wherein the longitudinal projections increase thermal transfer coefficient of the second jacket and increase thermal transfer from the second set of conductors; and
a third jacket surrounding the first jacket and the second jacket, the third jacket comprising:
an inner surface having a first cross-sectional profile; and
an outer surface having a plurality of surface features extending along the longitudinal axis of the multicore electrical cable, the surface features defining a non-linear circumference configured to enhance thermal dissipation, the outer surface of the third jacket having a second cross-sectional profile having a non-linear circumference defined by longitudinal projections and longitudinal channels between the longitudinal projections, wherein the longitudinal projections and the longitudinal channels extend longitudinally along the length of and parallel to the longitudinal axis and wherein the longitudinal projections increase thermal transfer coefficient of the third jacket and increase thermal transfer from the first jacket and the second jacket.

10. The multicore electrical cable of claim 9, wherein the outer surface of the second jacket comprises:
a ribbed outer surface, wherein the plurality of surface features of the ribbed outer surface comprise:
a plurality of longitudinal ribs, wherein each longitudinal rib extends continuously or intermittently along the longitudinal axis and outwards from the inner surface of the second jacket such that the second cross-sectional profile of the ribbed outer surface of the second jacket has a non-linear circumference with respect to the circumference of the second set of conductors, and wherein the plurality of longitudinal ribs of the ribbed outer surface of the first jacket create a plurality of longitudinal channels along the ribbed outer surface that are adapted to engage with the plurality of longitudinal ribs of the ribbed outer surface of the second jacket to interlock the first set of conductors and the second set of conductors.

11. The multicore electrical cable of claim 1, further comprising:
an insulator surrounding the first set of conductors; and
a shielding disposed on an external periphery of the insulator, wherein the insulator and the shielding are disposed between the first set of conductors and the first jacket, and wherein the first jacket surrounds the shielding.

12. A single core electrical cable having a longitudinal axis along the length of the single core electrical cable, the single core electrical cable, comprising:
a single conductor having a cross-sectional profile and an outer surface with a circumference; and
a single jacket encasing the single conductor, the single jacket comprising:
an inner surface surrounding the single conductor, the inner surface having a first cross-sectional profile that is substantially uniform with respect to the cross-sectional profile of the single conductor; and
an outer surface having a plurality of surface features extending along the longitudinal axis of the single core electrical cable, the plurality of surface features defining a non-linear circumference configured to enhance thermal dissipation,
the outer surface having a second cross-sectional profile that is substantially non-uniform with respect to the cross-sectional profile of the single conductor and the first cross-sectional profile.

13. The single core electrical cable of claim 12, wherein the plurality of surface features of the outer surface of the single jacket comprise:
a plurality of longitudinal projections extending in a direction parallel to the longitudinal axis, the longitudinal projections defining the non-linear circumference and forming longitudinal channels therebetween, wherein the longitudinal channels are configured to increase convective heat transfer from the single conductor,
wherein the second cross-sectional profile of the outer surface has the non-linear circumference defined by the longitudinal projections and the longitudinal channels between the longitudinal projections,
wherein the longitudinal projections and the longitudinal channels extend longitudinally along the length of and parallel to the longitudinal axis of the single core electrical cable, and
wherein the longitudinal projections increase thermal transfer coefficient of the single jacket and increase thermal transfer from the single conductor.

14. The single core electrical cable of claim 12, wherein the outer surface comprises: a ribbed outer surface, wherein the plurality of surface features of the ribbed outer surface comprise:
a plurality of longitudinal ribs, wherein each longitudinal rib extends continuously or intermittently along the longitudinal axis and outwards from the inner surface such that the second cross-sectional profile of the ribbed outer surface has a non-linear circumference with respect to the circumference of the single conductor, and wherein the plurality of longitudinal ribs create a plurality of longitudinal channels along the ribbed outer surface.

15. The single core electrical cable of claim 14, wherein each of the plurality of longitudinal ribs also extend longitudinally along the length of and parallel to the longitudinal axis of the single core electrical cable, and
wherein the plurality of longitudinal ribs forms longitudinal ridges therebetween running parallel along length of the single conductor.

16. The single core electrical cable of claim 14, wherein a shape of each of the plurality of longitudinal ribs corresponds to at least one of a semi-circular shape, a triangular shape, a trapezoidal shape, and a saw tooth shape.

17. The single core electrical cable of claim 14, wherein each of the plurality of longitudinal ribs extend longitudinally along the length of and parallel to the longitudinal axis of the single core electrical cable, and wherein the plurality of longitudinal ribs form one of:
straight longitudinal ridges extending around the single core electrical cable with an axial component of extension and a pitch greater than their height; and
helical ridges extending around the single core electrical cable with an axial component of extension that forms partially-longitudinal channels, wherein the helical ridges have a pitch greater than their height and extend around the single core electrical cable with a pitch angle between 5° and 85°.

18. The single core electrical cable of claim 14, wherein the single jacket is coated over the single conductor by way of an extrusion process using an extrusion die having a ribbed inner surface or fin-forming inner surface, wherein a shape of the ribbed inner surface or fin-forming inner surface of the extrusion die is complimentary to a shape of the ribbed outer surface of the single jacket.

19. The single core electrical cable of claim 12, further comprising:
an insulator surrounding the single conductor; and
a shielding disposed on an external periphery of the insulator, wherein the insulator and the shielding are disposed between the single conductor and the single jacket, and wherein the single jacket surrounds the shielding.

20. The single core electrical cable of claim 12, wherein the plurality of surface features increase the external convective heat transfer coefficient by at least 10% relative to a smooth cylindrical jacket of equal diameter.

21. The single core electrical cable of claim 12, wherein the ratio of height of the plurality of surface features to thickness of the single jacket is between 0.1 and 1.0.

22. The single core electrical cable of claim 12, wherein the outer surface exhibits at least a 5% increase in external surface area relative to a smooth cylindrical profile.

23. The single core electrical cable of claim 12, wherein the plurality of surface features act as spacers to maintain gap between the single core electrical cable and adjacent surfaces.

24. The single core electrical cable of claim 12, wherein the plurality of surface features deform elastically under radial compression to preserve channel geometry.

25. The single core electrical cable of claim 12, wherein the single jacket comprises a polymer including thermally conductive but electrically insulating fillers.

26. The single core electrical cable of claim 12, wherein the plurality of surface features comprise a material having higher thermal conductivity than the remainder of the single jacket.

27. A method of manufacturing an electrical cable having a longitudinal axis along the length of the electrical cable, the method comprising:
encasing a conductor in a polymer jacket, wherein the conductor has a cross-sectional profile and an outer surface with a circumference, wherein the polymer jacket has and outer surface and an inner surface surrounding the conductor, the inner surface having a first cross-sectional profile that is substantially uniform with respect to the cross-sectional profile of the conductor; and
extruding the polymer jacket through an extrusion die to encase the conductor, wherein the extrusion die has a ribbed inner surface with projections that form a plurality of longitudinal ribs on the outer surface of the electrical cable to produce a ribbed outer surface, wherein the projections have a shape that is complimentary to the shape of the ribbed outer surface of the jacket.

28. The method of manufacturing of claim 27, wherein the plurality of longitudinal ribs: extend outward from the inner surface of the polymer jacket and along the longitudinal axis of the electrical cable, create a plurality of longitudinal channels along the ribbed outer surface, and define a non-linear circumference configured to enhance thermal dissipation.

28. The method of manufacturing of claim 27, wherein the ribbed outer surface has a second cross-sectional profile that is substantially non-uniform with respect to the cross-sectional profile of the conductor and the first cross-sectional profile, and wherein the second cross-sectional profile has the non-linear circumference with respect to the circumference of the conductor.
